(19) United States
(12) Patent Application Publication
(10) Pub. No.: US 2024/0005899 A1
(43) Pub. Date: Jan. 4, 2024

(54) VENTILATION SYSTEM AND ACOUSTIC MEMBER

(71) Applicant: 3M INNOVATIVE PROPERTIES COMPANY, St. Paul, MN (US)

(72) Inventors: Keisuke SAWAMOTO, Sagmiharashi (JP); Shogo TEJIMA, Kawasaki-city (JP); Daigo YASUDA, Hachioji-city (JP)

(21) Appl. No.: 18/248,618

(22) PCT Filed: Oct. 12, 2021
(86) PCT No.: PCT/IB2021/059335

§ 371 Date: Apr. 11, 2023

(30) Foreign Application Priority Data
Oct. 13, 2020 (JP) 2020-172655

(51) Int. Cl. G10K 11/168; B60H 1/00; B32B 5/02; B32B 25/14; B32B 27/32; B32B 27/12; B32B 25/08

(52) U.S. Cl. CPC G10K 11/168; B60H 1/00507; B32B 5/022; B32B 25/14; B32B 27/32; B32B 27/12; B32B 25/08; B60H 2001/006; B32B 2262/0253; B32B 2262/16; B32B 2264/108; B32B 2307/718; B32B 2307/7242; B32B 2605/00; B32B 2307/102; B32B 2250/03; B32B 2250/40

(57) ABSTRACT

A ventilation system with an inlet and outlet, the ventilation system being mounted to a wall, the ventilation system including: an acoustic member absorbing sound from the outlet; the acoustic member includes a film-like body portion opposed to the outlet, and a periphery portion disposed to connect the body portion to the wall, the periphery portion disposed to surround the body portion, the body portion defines a first air chamber communicating with the outlet and a second air chamber into which air flows from the inlet, a portion of an outer edge of the body portion is fixed to the periphery portion, and a remainder of the outer edge of the body portion is open and is a communicating portion allowing the first air chamber to communicate with the second air chamber.

### TECHNICAL FIELD

One aspect of the present disclosure relates to a ventilation system and an acoustic member.

### BACKGROUND

Various types of ventilation systems and acoustic members are known. JP 2001-253229 A describes a ventilation structure provided in the interior of a load chamber of a vehicle.

2005-153622 A describes a vehicle vent duct arranged in the vehicle contour.

### SUMMARY

### Technical Problem

In the configuration in which the insulator is affixed to the back side of the trim, sound may pass along the insulator such that the insulator cannot sufficiently absorb and insulate, and there is room for improvement in sound absorption and sound insulation. In addition, in the vent duct provided with the breathable member that covers the concave part, there is a concern that air flow can be blocked due to the concave part being covered. Therefore, it is desirable not to restrict air flow from.

### Solution to Problem

A ventilation system according to one aspect of the present disclosure is a ventilation system with an inlet and an outlet, the ventilation system being mounted to a wall, the ventilation system including: an acoustic member absorbing sound from the outlet, where the acoustic member includes a body portion having a film-like shape, the body portion opposed to the outlet and a periphery portion disposed to connect the body portion to the wall, the periphery portion disposed to surround the body portion, the body portion defines a first air chamber communicating with the outlet and a second air chamber into which air flows from the inlet, a portion of an outer edge of the body portion is fixed to the periphery portion, and a remainder of the outer edge of the body portion is open and is a communicating portion allowing the first air chamber to communicate with the second air chamber.

In the ventilation system according to this embodiment, the acoustic member includes a film-like body portion opposed to the outlet formed in the wall. Since the body portion of the acoustic member is opposed to the outlet E, sound from the outlet can be effectively absorbed and insulated by the acoustic member to improve sound absorption and sound insulation. The body portion of the acoustic member partitions the internal space of the ventilation system into the first air chamber communicating with the outlet, and the second air chamber into which the air flows from the inlet of the ventilation system. The body portion defines the first air chamber and the second air chamber in this manner, thereby absorbing and insulating the sound from the outlet more effectively. Further, the portion of the outer edge of the body portion of the acoustic member is fixed to the periphery portion of the acoustic member, and the remainder of the outer edge of the body portion is the communicating portion that allows the first air chamber to communicate with the second air chamber. Thus, the air flowing into the second air chamber from the inlet can be passed to the outlet through the communicating portion and the first air chamber. Therefore, it is possible to prevent the flow of the air from being inhibited.

An inner member that defines the second air chamber together with the body portion may be provided, where the inlet may be formed in the inner member.

The inner member may be connected to the wall.

A lower portion of the outer edge of the body portion may be fixed to the periphery portion.

In the communicating portion, air flowing into the second air chamber from the inlet may flow into the first air chamber, and at the outlet, the air flowing from the communicating portion into the first air chamber may be discharged from the first air chamber.

The body portion may have a film-like shape extending in a first direction and a second direction, the wall and the body portion may be aligned along a third direction, the third direction intersecting both of the first direction and the second direction, the outlet and the inlet are formed on one side in any of the first direction and the second direction, and the communicating portion may be formed on the other side in any of the first direction and the second direction.

The one side in the first direction and the second direction may be a lower side, and the other side in the first direction and the second direction may be an upper side.

The wall may include an outer wall and an inner wall, the outlet may be formed in the outer wall, and at least a portion of the periphery portion may be mounted to the inner wall.

The outer wall may be an outer panel of an automobile, the inner wall may be an inner panel of the automobile, and the outlet may be a vent duct of the automobile.

The inner member may be a luggage side trim covering an inner side of the wall.

The acoustic member may include a nonwoven fabric.

The acoustic member may include a skin layer and a core layer that includes a material different from a material of the skin layer.

The acoustic member may include a porous layer and a non-uniform filler that contacts the porous layer, the non-uniform filler containing porous carbon and having an average surface area of 0.1 m²/g or more and 10000 m²/g or less, and the acoustic member may have an air-flow resistance value of 100 MKS Rayls or more and 5000 MKS Rayls or less.

The acoustic member may include a porous layer and a non-uniform filler that is received in the porous layer, the non-uniform filler having an average particle size of 1 μm or more and 1000 μm or less, and having an average surface area of 0.1 m²/g or more and 800 m²/g or less, and the acoustic member may have an air-flow resistance value of 100 MKS Rayls or more and 8000 MKS Rayls or less.

An acoustic member according to one aspect of the present disclosure includes a body portion having a film-like shape, and a periphery portion formed to be connected to a portion of the outer edge of the body portion, the periphery portion formed to surround the body portion.

In the acoustic member according to this embodiment, since the film-like body portion is opposed to the outlet, sound from the outlet can be effectively absorbed and insulated by the body portion to improve sound absorption and sound insulation. Since the acoustic member includes the periphery portion formed to be connected to a portion of an outer edge of the body portion, the periphery portion formed to surround the body portion, the remainder of the outer edge of the body portion can be open when the periphery portion is mounted to the wall or the like. This open portion can be a passage for air so as to prevent the flow of the air from being inhibited.

The periphery portion may be formed by thermal pressing.

The periphery portion may be formed of a frame.

The body portion may partition a predetermined space into a first air chamber and a second air chamber, the portion of the outer edge of the body portion may be fixed to the periphery portion, the remainder of the outer edge of the body portion may be open and may be a communicating portion that allows the first air chamber to communicate with the second air chamber.

### Examples of Advantageous Effects

According to one aspect of the present disclosure, it is possible to allow air flow while improving sound absorption and sound insulation.

### BRIEF DESCRIPTION OF THE DRAWINGS

FIG. 1 is a view schematically illustrating an exemplary wall to which a ventilation system according to an embodiment is mounted.

FIG. 2 is a view illustrating an exemplary inner member of the ventilation system mounted to the wall.

FIG. 3 is a view schematically illustrating a portion of the exemplary wall to which the ventilation system is mounted.

FIG. 4 is a schematic sectional view of the ventilation system according to the embodiment.

FIG. 5 is a view schematically illustrating a layer structure of an exemplary acoustic member.

FIG. 6 is a schematic view illustrating locations of a speaker and a microphone that are disposed in an experiment using the acoustic member.

FIG. 7 is a schematic view illustrating locations of the speaker and the microphone that are disposed in the experiment using the acoustic member.

FIG. 8 is a graph illustrating the relationship between the sound frequency and noise obtained as a result of the experiment.

FIG. 9 is a graph illustrating the relationship between the sound frequency and noise obtained as a result of the experiment.

### DETAILED DESCRIPTION

Hereinafter, embodiments of a ventilation system and an acoustic member according to the present disclosure will be described below with reference to the accompanying drawings. In the description of the drawings, the same or corresponding elements are denoted by the same reference signs, and redundant description will be appropriately omitted. In addition, the drawings may be simplified or exaggerated in part for ease of understanding, and the dimensional ratios, etc. are not limited to those illustrated in the drawings.

First, the term “ventilation system” according to the present disclosure refers to a device, equipment, member, or portion capable of allowing air to flow from one side of a wall to the other side of the wall. The term “wall” refers to a member that partitions a space, and is a panel as an example. Note that spaces facing the one side and the other side of the wall each may be a closed space or an open space. The term “outlet” refers to an opening formed in the wall, through which air flows from one side to the other side of the wall. The term “inlet” refers to an opening formed in the ventilation system, through which air flows into the ventilation system.

The term “sound absorption” refers to absorbing sound, and “sound insulation” refers to insulating sound. The term “acoustic member” refers to a member or portion that performs at least one of sound absorption and sound insulation. The term “film-like” refers to a two-dimensionally extending state. The term “body portion” refers to a main portion or member of the acoustic member, for example, a main portion of an acoustic member that absorbs or insulates sound. The term “porous” means a property having air permeability.

The term “periphery portion” refers to a portion of periphery of the body portion. The term “first air chamber” refers to one of a pair of spaces obtained by dividing a predetermined space, and the term “second air chamber” refers to the other of the pair of spaces. The term “inner” refers to one side of the wall and the term “inner member” refers to a member or portion that is disposed on the one side of the wall. The term “outer wall” refers to a wall provided outside, and the term “inner wall” refers to a wall provided inside, when viewed from the space defined by the wall among walls.

The term “luggage side trim” refers to a cover for covering a surface on one side of the wall that defines a space. The term “automobile” refers to a moving body that includes a vehicle body, wheels supporting the vehicle body, and a power source, wherein for moving, the wheels are driven by the motive power of the power source. The term “outer panel” refers to an outer plate of the vehicle body of the automobile, and the term “inner panel” refers to an inner plate of the vehicle body of the automobile. The term “vent duct” refers to a portion that is provided in the vehicle body of the automobile, and allows air to flow into/out of the vehicle body.

The acoustic member and the ventilation system according to embodiments absorb sound from the outlet (sound absorption). An object to which the acoustic member or the ventilation system is mounted may be transportation equipment, machine, building, or other structures that include an automobile, an electric vehicle, or an aircraft. When being mounted to a wall, the acoustic equipment and the ventilation system according to the embodiments absorb or insulate sound passing through the wall, while ensuring air flow inside and outside the wall.

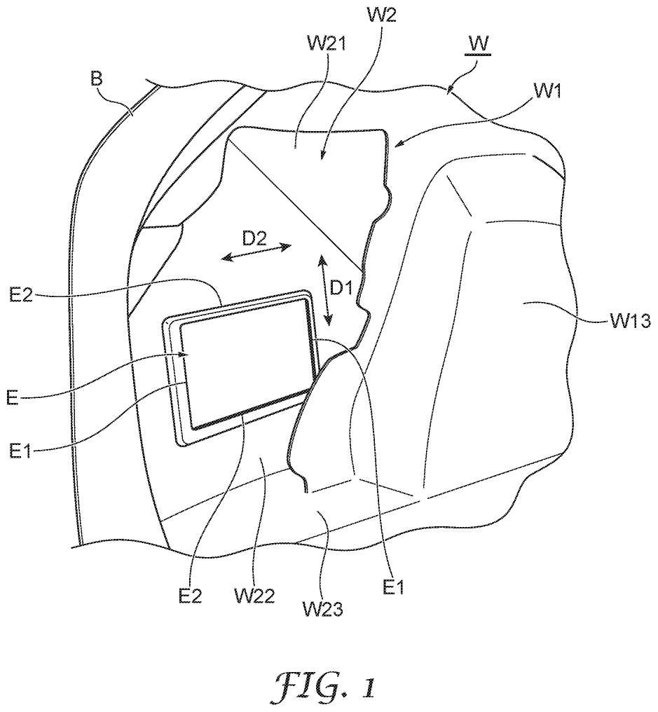

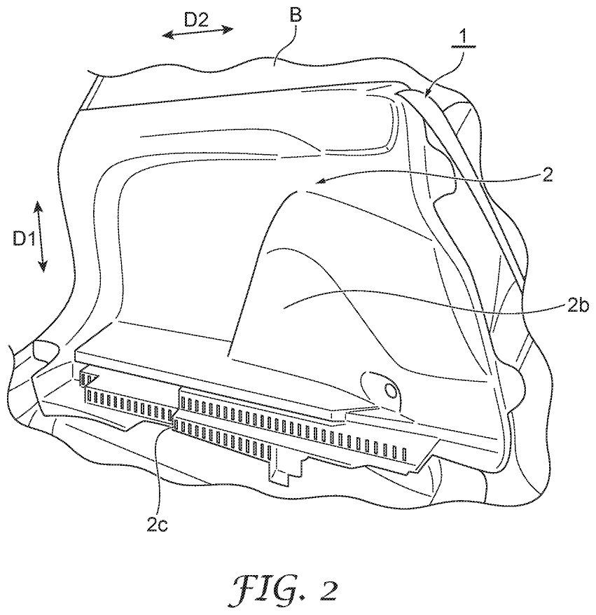

FIG. 1 is a view illustrating an exemplary wall W of an object to which the ventilation system according to the embodiment is mounted. FIG. 2 is a view schematically illustrating an exemplary ventilation system 1 according to the embodiment. As illustrated in FIGS. 1 and 2, for example, the wall W constitutes a rear panel of a vehicle body B of an automobile. The wall W includes an inner wall W1 positioned inside the vehicle body B, and an outer wall W2 positioned more outside the vehicle body B than inner wall W1. For example, the inner wall W1 is an inner panel of the vehicle body B, and the outer wall W2 is an outer panel of the vehicle body B.

The outer wall W2 includes, for example, a first wall portion W21, a second wall portion W22 positioned below the first wall portion W21, and a third wall portion W23 that extends from one end of the second wall portion W22 in a direction intersecting (ex., orthogonal to) the second wall portion W22. As an example, the inner wall W1 has a concave-convex shape including a convex portion W13 protruding toward the inside of the vehicle body B. For example, an outlet E for discharging air from the inside to the outside of the vehicle body B is formed in the second wall portion W22.

The outlet E is a vent duct of the vehicle body B, for example. The outlet E has, for example, a rectangular shape having a pair of short sides E1 that extend along a first direction D1 and a pair of long sides E2 that extend along a second direction D2 intersecting the first direction D1. For example, the first direction D1 indicates the vertical direction, and the second direction D2 indicates the front-back direction of the automobile. As an example, the first direction D1 is orthogonal to the second direction D2. However, the first direction D1 may not be orthogonal to the second direction D2. Further, the shape of the outlet E may have a shape other than rectangle, and is not particularly limited.

For example, an inner member 2 of the ventilation system 1 is mounted to the inner wall W1. The inner member 2 covers the wall W (the inner wall W1 and the outer wall W2) from the inside of the vehicle body B. As an example, the inner member 2 is a luggage side trim of the vehicle body B. For example, the inner member 2 has a concave-convex shape including a convex portion 2b protruding toward the inside of the vehicle body B, and the concave-convex shape of the inner member 2 corresponds to the concave-convex shape of the inner wall W1. The inner member 2 has an inlet 2c that allows air to flow into the ventilation system 1. The inlet 2c is shaped like a slit linearly extending along the first direction D1, for example. The inner member 2 includes a plurality of the inlets 2c, and for example, the plurality of inlets 2c are aligned in the second direction D2.

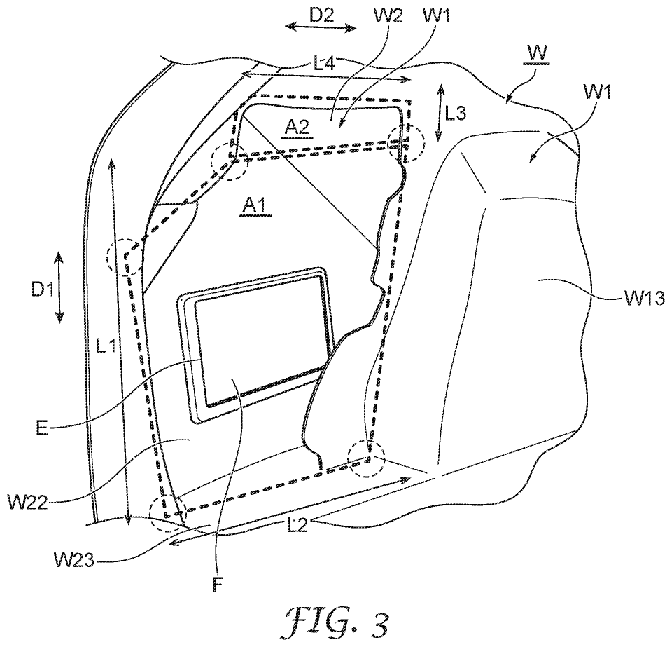

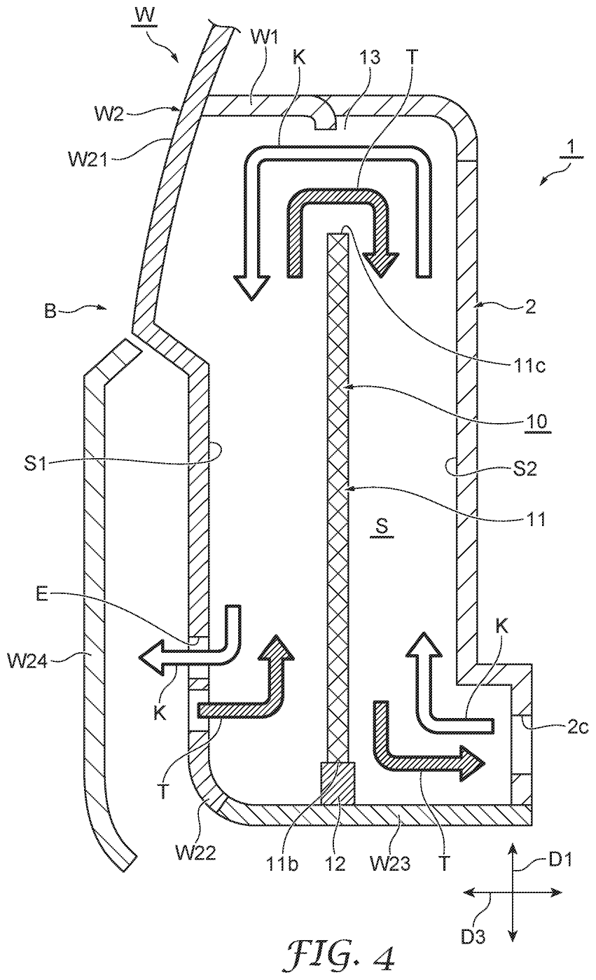

FIG. 3 is a view for describing the position at which the ventilation system 1 is mounted to the wall W. FIG. 4 is a longitudinal sectional view of the ventilation system 1. As schematically illustrated in FIGS. 3 and 4, the ventilation system 1 covers, from the inside of the vehicle body B, a first region A1 opposed to the second wall portion W22 of the outer wall W2 and a second region A2 located above the first region A1. The first region A1 is a region opposed to the acoustic member 10 according to the embodiment, and the second region A2 is a region that is not opposed to the acoustic member 10 (a region forming a communicating portion 13 described below).

For example, a length L1 of the first region A1 in the first direction D1 may be 300 mm or more and 1000 mm or less, and a lower limit of the length L1 may be 400 mm or 500 mm. An upper limit of the length L1 may be 900 mm, 800 mm, or 700 mm. A length L2 of the first region A1 in the second direction D2 is, for example, 100 mm or more and 800 mm or less. A lower limit of the length L2 may be 200 mm, 300 mm or 400 mm and an upper limit of the length L2 may be 700 mm, 600 mm, or 500 mm. As an example, the length L1 is 600 mm and the length L2 is 450 mm.

A length L3 of the second region A2 in the first direction D1 is, for example, 20 mm or more and 600 mm or less. A lower limit of the length L3 may be 40 mm, 60 mm, 80 mm or 120 mm and an upper limit of the length L3 may be 400 mm, 250 mm, 200 mm, or 150 mm. A length L4 of the second region A2 in the second direction D2 is, for example, 100 mm or more and 500 mm or less. A lower limit of the length L4 may be 200 mm and an upper limit of the length L4 may be 400 mm or 300 mm. As an example, the length L3 is 100 mm and the length L4 is 250 mm.

The ventilation system 1 includes the inner member 2 and an acoustic member 10 opposed to the outlet E inside the vehicle body B. The acoustic member 10 includes a body portion 11 opposed to the outlet E and absorbs or insulates sound from the outlet E, and a periphery portion 12 provided to surround the body portion 11. For example, the body portion 11 is a portion that exerts an acoustic effect, and the periphery portion 12 is a portion including a portion that does not exert an acoustic effect and is fixed to the wall W. The body portion 11 is film-like. The body portion 11 extends in the first direction D1 and the second direction D2, and has a thickness in a third direction D3 intersecting both of the first direction D1 and the second direction D2.

The acoustic member 10 (e.g., the periphery portion 12) may be manufactured, for example, by cutting out a flexible sheet-like material. The periphery portion 12 may be fixed to the wall W by a single-sided adhesive tape, a double-sided adhesive tape, an adhesive, a mechanical fastener, or a clip. The periphery portion 12 may be intermittently or continuously fixed, for example, at three locations, four locations, five locations (where the dashed circle points in FIG. 3 as an example), or more locations by tape. In the acoustic member 10, the edge of the cut portion cut out as described above may not specifically processed, but some or all of a region in the range of approximately 1 mm to 20 mm from this edge may be thermally pressed to be hardened. The thermal pressing may be continuously, intermittently, or discontinuously made in the direction along the edge. In addition, the acoustic member 10 may be fixed with the height of the above-mentioned sheet-like material being adjusted with respect to a pre-formed frame (or a U-shaped frame where a part is open).

A portion 11b of an outer edge of the body portion 11 is fixed to the periphery portion 12. The portion 11b is, for example, a portion that includes a lower portion of the body portion 11. Each of both ends of the body portion 11 in the second direction D2 may be fixed to the periphery portion 12. The portion 11b of the body portion 11 is, for example, a region including an outer edge of the first region A1, and the body portion 11 (the portion 11b) along the outer edge of the first region A1 may be fixed to the periphery portion 12. A remainder 11c of the body portion 11 is open, for example, is a free end. In this case, the remainder 11c of the body portion 11 is not fixed to anywhere. The remainder 11c of the body portion 11 is opposed to the inner wall W1 via the communicating portion 13 described below.

The periphery portion 12 is film-like. The periphery portion 12 may be formed by thermal pressing. Also, the periphery portion 12 may be formed of a frame that surrounds at least a portion of the body portion 11. A portion of the periphery portion 12 may be bent from the portion 11b of the outer edge of the body portion 11 and extend along a plane intersecting both of the first direction D1 and the second direction D2. The periphery portion 12 extends along the outer edge of the first region A1, and is fixed to the portion 11b of the body portion 11 at the location along the outer edge of the first region A1.

For example, the wall W includes the outer wall W2 including the second wall portion W22 provided with the outlet E, and the inner wall W1 located inner than the outer wall W2. The inner wall W1 protrudes from the outer wall W2 to the inside of the vehicle body B, and the inner member 2 is fixed thereto. For example, when viewed from the outlet E and the second wall portion W22, a rear bumper W3 is provided outside the vehicle body B, and air K discharged from the outlet E passes between the rear bumper W3 and the second wall portion W22 and is discharged to the outside of the vehicle body B.

The inner member 2 is provided on the opposite side to the outer wall W2 across the inner wall W1. The inner member 2 extends between the periphery portion 12 and the inner wall W1 in the first direction D1 and the second direction D2. In the state where the ventilation system 1 is mounted to the outlet E of the wall W, for example, the inner member 2, the acoustic member 10 (the body portion 11), the outer wall W2 (the second wall portion W22), and the rear bumper W3 are aligned in this order along the third direction D3. The inner member 2, the inner wall W1, and the outer wall W2 define an internal space S of the ventilation system 1.

The body portion 11 of the acoustic member 10 partitions the internal space S into a first air chamber S1 that communicates with the outlet E, and a second air chamber S2 into which the air K flows from the inlet 2c. As described above, the portion 11b of the outer edge of the body portion 11 is fixed to the periphery portion 12, the periphery portion 12 is fixed to the wall W, and the remainder 11c of the outer edge of the body portion 11 is open. The communicating portion 13 that allows the first air chamber S1 to communicate with the second air chamber S2 is formed in the remainder 11c of the body portion 11.

The inner member 2 includes the inlet 2c that allows the air K to flow into the ventilation system 1. The inlet 2c is formed, for example, at one end (lower end as an example) of the ventilation system 1 in the first direction D1. The air K flowing into the second air chamber S2 from the inlet 2c reaches the communicating portion 13. The communicating portion 13 is formed, for example, at the other end (upper end as an example) of the ventilation system 1 in the first direction D1.

The air K that has reached the communicating portion 13 enters the first air chamber S1 from the communicating portion 13, and reaches the outlet E. For example, the outlet E is formed at one end (the lower end as an example) of the ventilation system 1 in the first direction D1. For example, the air K that has flowed from the inlet 2c into the internal space S (the second air chamber S2) of the ventilation system 1 flows in an inverted-U manner, bypasses the body portion 11 of the acoustic member 10, reaches the outlet E, and is discharged from the ventilation system 1.

For example, a flap F shaped like a rubber plate (see FIG. 3) is mounted to the outlet E. The flap F is mounted in the outlet E so as to be swingable in the third direction D3, and functions as a valve for the outlet E. For example, even while the flap F is closed during driving, sound T such as road noise and wind noise occurs, and the sound T enters from the outlet E into the internal space S of the ventilation system 1. As schematically illustrated in FIG. 4, the sound T partially flows from the first air chamber S1 into the second air chamber S2 through the communicating portion 13. However, the remainder of the sound T is absorbed by the body portion 11 of the acoustic member 10.

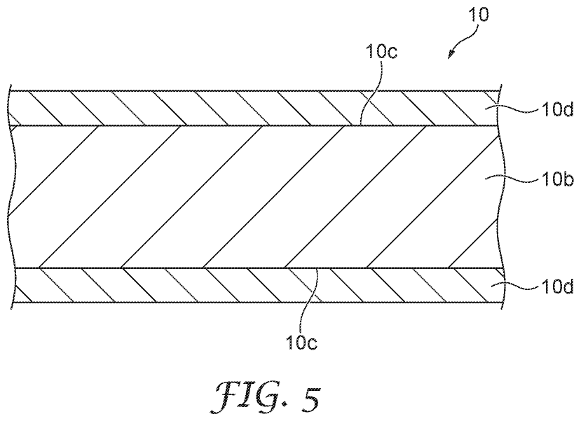

FIG. 5 is a view illustrating an exemplary layer structure of the acoustic member 10 (each of body portion 11 and the periphery portion 12). As illustrated in FIG. 5, the acoustic member 10 includes a core layer 10b, and a skin layer 10d formed on at least one of a pair of main surfaces 10c of the core layer 10b. FIG. 5 illustrates an example in which the skin layer 10d is formed on each of the pair of main surfaces 10c of the core layer 10b. However, the skin layer 10d may be formed on only one of the main surfaces 10c of the core layer 10b. The skin layer 10d functions as the outermost layer of the core layer 10b, for example.

The material of the core layer 10b and the material of the skin layer 10d may be the same as or different from each other. For example, the material of the core layer 10b and the material of the skin layer 10d may include polypropylene (PP). The type of the core layer 10b is not particularly limited, and various sound absorbing materials can be used as the core layer 10b. At least one of the core layer 10b and the skin layer 10d may be omitted. For example, the core layer 10b includes one or more porous layers. Examples of the useful porous layer may include nonwoven fabrics, felts, urethane foam materials, microfibers, perforated films, particulate bed, open cell foams, fiberglass, nets, woven fabrics, or combinations thereof. Note that the skin layer 10d may also include one or more porous layers. The exemplary skin layer 10d and core layer 10b each may include at least one of meltblown fibers, staple fibers, and binder fibers. The material of the acoustic member 10 is not particularly limited and may include rubber. In other words, the acoustic member 10 may be, for example, a rubber plate.

The acoustic member 10 is constituted of meltblown microfibers, for example. Both the core layer 10b and the skin layer 10d may be constituted of meltblown microfibers, or only one of the core layer and the skin layer may be constituted of meltblown microfibers.

The acoustic member 10 may include at least one of meltblown fibers, staple fibers, and binder fibers. The binder fibers may be dispersed in the meltblown fibers or at least a part thereof may be melt-bonded to meltblown fibers. The binder fibers may have at least a part thereof melt-bonded by high melting-point meltblown fibers to function as a binder.

The meltblown fibers of the core layer 10b or the skin layer 10d may be a resin having a higher melting point than the melt-bonded portions of the binder fibers, and may be a fibrous material produced using a melt-blowing process. The “melt-blowing process” refers to a method of blowing a high-temperature air stream onto a fibrous resin extruded from a nozzle, thereby making the fiber diameter more fine.

For example, the acoustic member 10 is a film-like acoustic member. An exemplary acoustic member 10 includes: meltblown fibers having a fiber diameter of 10 μm or less; binder fibers that are dispersed in the meltblown fibers and at least a part thereof being melt-bonded to the meltblown fibers; and staple fibers.

The fiber material of the staple fibers may be any of polyester, polyamide, acrylic, polypropylene, polyethylene, and the like, but it is preferable to include polyester fibers from the perspective of weather resistance, flame retardancy, and recyclability. The thickness of the staple fibers is, for example, 1 denier or more and 100 denier or less.

The thickness of the staple fibers is preferably thick in terms of processability and handling, and is preferably 3 denier or more and 50 denier or less in consideration of improving productivity in a hopper feeder. Note that the thickness of the staple fibers is preferably narrow in terms of sound absorption, and is preferably 15 denier or less in particular, in order to improve the sound absorption of 200 to 1500 Hz, which is a low sound range.

The fiber length of the staple fibers is preferably 30 mm or more and 100 mm or less from the perspective of processability and handling. The shape of the cross-section of the staple fibers may be any of circular shape, T shape, and flat shape, or may be hollow fibers. The staple fibers may be crimped fibers, for example, the crimped state can be any of corrugated, spiral, and mixture of corrugated and spiral. When the number of crimps is too small, elasticity and hardness are insufficient, and when the number of crimps is too large, processing troubles may occur. For example, fibers of 5 to 200 crimps/25 mm, and more preferably 10 to 50 crimps/25 mm are used.

Fibers having a lower melting point than the melting point of the high melting-point meltblown fibers can be used at least in a part of the surface, as the binder fibers included in the acoustic member 10. For example, the melting point of the low melting-point portion of the binder being lower than the melting point of the meltblown fibers by 10° C. or higher (or 20° C. or higher) can be used. For example, low melting-point polyethylene terephthalate (PET), polypropylene (PP), polyethylene (PE), or the like can be used as the low melting-point portion of the binder fibers.

For example, when polybutylene terephthalate (PBT) having a melting point of approximately 220° C. is used as the meltblown fibers, or when polypropylene having a melting point of approximately 160° C. is used as the meltblown fibers, a low melting-point polyethylene terephthalate (PET) having a surface melting point of 110° C. can be used as the binder fibers. Note that when used as a sound absorbing member for a vehicle, to withstand an environmental resistance test, the melting point of the binder fibers may be 90° C. or higher, 100° C. or higher, or 120° C. or higher.

The binder fibers may be fibrous, and the cross-sectional diameter and length of the binder fibers are not particularly limited. In terms of increasing dispersibility, the binder fibers may be short fibers. Staple fibers having a fiber length of 10 mm or more and 100 mm or less, which are produced by cutting the spun fibers, can be used as the binder fibers. Since the contact density of the fibrous binder with the meltblown fibers is high at least in a part thereof, efficient melt-bonding between fibers is possible and the amount of binder fibers required can be suppressed.

The binder fibers may not be a material having a uniform melting point, or may be provided with at least a low melting point layer on the surface. For example, the binder fibers may be fibers having a core-sheath structure, and only sheath portions may have a low melting point. In using fibers having such core-sheath structure, when mixed with the meltblown fibers, only the low melting-point binder of the sheath portions melts and core portions remain as fibers together with the meltblown fibers, such that air-flow resistance can be improved without inhibiting the properties of the meltblown fibers. Note that the partially meltable binder fibers are melted to adhere the meltblown fibers to each other, making it possible to facilitate handling.

The acoustic member 10 may have a polymeric nonwoven fabric layer, which may be made by a melt-blowing process. The meltblown polymeric nonwoven fabric layer may include very thin fibers. In melt blowing, a thermoplastic polymer stream is extruded from an orifice of a die and is attenuated by a converging stream of hot air to form fine fibers. The acoustic member 10 may be made by melt spinning.

Fibers made by melt spinning as described above may be spunbonded. Webs including a set of melt spun fibers are collected as fibrous webs. The acoustic member 10 may include meltspun fibers. The resin constituting these fibers may include polyolefin such as polypropylene or polyethylene, polyester, polyethylene terephthalate, polybutylene terephthalate, polyamide, polyurethane, polybutene, polylactic acid, polyphenylene sulfide, polysulfone, liquid crystal polymer, polyethylene-co-vinyl acetate, polyacrylonitrile, cyclic polyolefins, or copolymers or mixtures thereof. The acoustic member 10 may be made from a thermoplastic semi-crystalline polymer. Thermoplastic semi-crystalline polymers include semi-crystalline polyesters or aliphatic polyesters.

The molecular weight of the aliphatic polyester described above is not particularly limited. The molecular weight may be, for example, 15000 (g/mol) or more and 6000000 (g/mol) or less; 20000 (g/mol) or more and 2000000 g/mol or less; or 40000 (g/mol) or more and 1000000 g/mol or less. The molecular weight may be 25 (g/mol) or more. Further, the molecular weight may be any of 15000 (g/mol), 20000 (g/mol), 25000 (g/mol), 30000 (g/mol), 35000 (g/mol), 40000 (g/mol), 45000 (g/mol), 50000 (g/mol), 60000 (g/mol), 70000 (g/mol), 80000 (g/mol), 90000 (g/mol), 100000 (g/mol), 200000 (g/mol), 500000 (g/mol), 700000 (g/mol), 1000000 (g/mol), 2000000 (g/mol), 3000000 (g/mol), 4000000 (g/mol), 5000000 (g/mol), and 6000000 (g/mol).

The acoustic member 10 may include a polymeric nonwoven fabric layer, and the diameter of the fibers of the polymeric nonwoven fabric layer is not particularly limited. The diameter may be, for example, 0.1 μm or more and 10 μm or less; 0.3 μm or more and 6 μm or less; or 0.3 μm or more and 3 μm or less. The diameter may be less than 0.1 μm. Further, the diameter may be any of 0.2 μm, 0.3 μm, 0.4 μm, 0.5 μm, 0.6 μm, 0.7 μm, 0.8 μm, 0.9 μm, 1 μm 1.5 μm, 2 μm, 2.5 μm, 3 μm, 3.5 μm, 4 μm, 4.5 μm, 5 μm, 5.5 μm, 6 μm, 6.5 μm, 7 μm 7.5 μm, 8 μm, 8.5 μm, 9 μm, 9.5 μm, 10 μm, 11 μm 12 μm, 13 μm, 14 μm 15 μm, 16 μm, 17 μm, 18 μm, 19 μm, 20 μm, 22 μm, 25 μm, 27 μm, 30 μm 32 μm, 35 μm, 37 μm, 40 μm, 42 μm, 45 μm, 47 μm, 50 μm, 53 μm, 55 μm, 57 μm, and 60 μm.

The acoustic member 10 may have a porous polymer (may be a porous layer). That is, the acoustic member 10 may be a layer having a plurality of fine holes therein. The acoustic member 10 may be a perforated film or may be an open cell foam. When the acoustic member 10 has fine holes, the average diameter of the holes may be 10 μm or more and 5000 μm or less. Also, the average diameter of the holes may be any of 10 μm, 15 μm, 20 μm, 25 μm, 30 μm, 35 μm, 40 μm, 45 μm, 50 μm, 55 μm, 60 μm, 70 μm, 80 μm, 90 μm, 100 μm, 110 μm, 120 μm, 150 μm, 170 μm, 200 μm, 300 μm, 350 μm, 400 μm, 500 μm, 600 μm, 700 μm, 800 μm, 900 μm, 1000 μm, 1500 μm, 2000 μm, 3000 μm, 4000 μm, and 5000 μm. The shape of the hole is not limited to circle, and may be polygonal or may be oval. For more clarity, the diameter of a non-circular hole is defined herein as the diameter of a circle having an area equivalent to a non-circular hole in plan view.

When the acoustic member 10 includes holes, the porosity of the acoustic member 10 may be, for example, 0.1% or more and 80% or less, 0.2% or more and 70% or less, or 0.5% or more and 60% or less. The porosity of the acoustic member 10 may also be any of 0.2%, 0.3%, 0.4%, 0.5%, 0.7%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, and 80%.

The acoustic member 10 may be configured of fiber-glass. The acoustic member 10 may constitute a Helmholtz resonator. The acoustic member 10 may include at least one of a polymer composition and an inorganic composition. The acoustic member 10 may be film-like. The acoustic member 10 may have through holes.

The acoustic member 10 may include a porous layer, which exhibits excellent acoustic absorption over a wide range of frequency bands. At least one of organic particles and inorganic particles may be included in the porous layer of the acoustic member 10. In this case, synergistic acoustic absorption can be achieved.

The porous layer that constitutes the acoustic member 10 may be in contact with or may include at least one non-uniform filler capable of improving acoustic performance. Examples of the non-uniform filler include organic particles, inorganic particles, and porous particles, and the preferable non-uniform filler is porous particles. This non-uniform filler may be characterized by open pores, closed pores, or a combination thereof. The non-uniform filler may be rigid such that movement of the filler material is negligible compared to the movement of the fluid phase (e.g., air) within the acoustic environment. In the acoustic member 10, the non-uniform filler described above may form a gap in the porous medium that generates the acoustic absorption profile. The configuration of this acoustic absorption profile can be adjusted by a combination of particle properties.

Examples of filler particles having open pores include zeolites, aerogels, porous alumina, mica, perlite, particulate polyurethane foam particles, metal organic structures (MOF), or porous carbon materials. Examples of filler particles having closed pores include closed cell foam particles and hollow particles. Examples of the hollow particles having a single pore (or cavity) include expanded polymer microspheres, ceramic microspheres, and hollow glass bubbles.

The non-uniform filler may be present in various configurations relative to the porous layer. For example, when the porous layer is a nonwoven fabric fibrous layer, an open-cell foam, or a particulate bed, the non-uniform filler may be embedded in the nonwoven fabric fibrous layer, the open cell foam, or the particulate bed. When the porous layer includes a perforated film, the non-uniform filler may be at least partially present in a plurality of apertures extending over the perforated film. In some embodiments, at least 5%, at least 10%, at least 20%, at least 30%, at least 40%, at least 50%, at least 60%, at least 70%, at least 80%, at least 90%, or at least 95% of the non-uniform filler contacting the porous layer may be present in the plurality of apertures. Alternatively, the non-uniform filler may be present as a discrete layer adjacent the porous layer.

The porous particles can include macropores (having a width of greater than 50 nanometers), mesopores (having a width of less than 50 nanometers and greater than 2 nanometers), micropores (having a width of less than 2 nanometers), and/or combinations of the above. Examples of the non-uniform fillers include porous carbon particles. Examples of the porous carbon particles include activated carbon or vermiform carbon.

Activated carbon is a highly porous carbonaceous material having a composite structure constituted mainly of carbon atoms. The activation method can be carried out using steam at an elevated temperature of about 1000° C., or in some cases, using phosphoric acid at a lower temperature. The network of pores in the activated carbon is a channel formed in the rigid skeleton of the disordered layer of carbon atoms, and are connected to each other by chemical bonds and are non-uniformly stacked. This creates a very porous structure formed by a lot of pits and cracks in the carbon layer.

One characteristic of activated carbon is adsorption of gas molecules. 1 m³ of activated carbon having an internal pore volume of 0.3 m³ can absorb 30 m³ or more gases. The behavior of porous carbon in an acoustic article is consistent with the adsorption of surrounding air molecules. When the porous carbon adsorbs air molecules in a limited space, the effective air volume may be greater than twice the volume of air in an identical space without porous carbon. By expanding the effective air volume within the acoustic cavity, the porous carbon tends to shift the acoustic resonant frequency from high to low. This frequency shift may be interpreted as a quarter wavelength reduction in acoustic absorption (or slowing of the speed of sound in the acoustic medium), providing high acoustic performance in thinner layers.

The vermiform carbon (or vermiform graphite) is a layered form of porous carbon made by introducing guest molecules penetrating the graphite layer into the expandable graphite. At high temperatures, the guest molecules undergo phase change. This reaction of the phase change causes a sufficient pressure to spread the graphite layer apart, and without limitation, the volume of the particles increases rapidly. The expandable graphite has an insect-like structure known as vermiform graphite.

The vermiform graphite is notable because it lacks micropores (pores less than 2 nm) and has a larger pore structure than the activated carbon. The surface area of the vermiform carbon is less than 1 m²/g, and is smaller than the surface area of the activated carbon by a few orders. From these differences, the vermiform carbon can be more effectively used to attenuate higher frequency noise than the activated carbon. As a result, to increase acoustic absorption over a wide frequency range, it may be advantageous to use a mixture of the activated carbon and the vermiform carbon.

The average size of the particles constituting the non-uniform filler may be related not only to the mechanical properties of the acoustic article, but also to the processing considerations that affect acoustic absorption. In the vermiform graphite, for example, smaller platelets produce a layer with a higher overall ratio of the edge area to the internal volume. As the particle size decreases, the efficiency of the outflow path of inflation gas increases, reducing the likelihood of overall expansion, and reducing the pore size.

It has been found that the temperature at which the vermiform graphite is processed also affects the acoustic performance, and particles processed at higher temperatures tend to exhibit a higher degree of expansion between the layers. Using a spring model of the graphite layer, the spring expands more, that is, the flexibility of the spring increases, which improves acoustic damping.

Except for aggregates, the non-uniform filler may have an average particle size of 0.1 micrometers to 2000 micrometers, 5 micrometers to 1000 micrometers, or 10 micrometers to 500 micrometers. Also in some embodiments, the non-uniform filler may have an average particle size that is less than, is equal to, or larger than 0.1, 0.2, 0.5, 1, 2, 5, 7, 10, 15, 20, 30, 40, 50, 70, 100, 200, 300, 400, 500, 600, 700, 800, 900, 1000, 1200, 1500, 1700, or 2000 micrometers.

Due to its porous nature, the non-uniform filler has a large surface area, such that it can have adsorption capacity. Having a high surface area density can reflect the high complexity and torsion of the pore structure, resulting in greater internal reflection and energy transfer to the solid structure due to frictional losses. This appears as an absorption of airborne noise. The average surface area of the non-uniform filler may be 0.1 m²/g to 10000 m²/g, 0.5 m²/g to 5000 m²/g, or 1 m²/g to 2500 m²/g. Also in some embodiments, the non-uniform filler may have an average surface area that is less than, is equal to, or larger than 0.1, 0.2, 0.5, 0.7, 1, 2, 5, 10, 20, 50, 100, 120, 150, 200, 250, 300, 350, 400, 450, 500, 1000, 1500, 2000, 2500, 3000, 3500, 4000, 4500, 5000, 6000, 7000, 8000, 9000, or 10000 m²/g.

In some embodiments, the high surface density of the non-uniform filler is due to the presence of very fine pores. The activated carbon, for example, exhibits micropores having a size of less than 2 nm, which accounts for the majority of the surface area in the carbon particles.

The non-uniform filler may have a number average pore size of 0.1 nanometer to 50 micrometers, 1 nanometer to 40 micrometers, or 2.5 nanometers to 30 micrometers. Also, in some embodiments, the non-uniform filler may have a number average pore size that is less than, equal to, or greater than 0.1, 0.2, 0.3, 0.4, 0.5, 1 nanometer, 1.2, 1.5, 1.7, 2, 3, 4, 5, 7, 10, 15, 20, 25, 30, 40, 50, 70, 100, 150, 200, 250, 300, 350, 400, 450, 500, 600, 700, 800, 900 nanometers, 1 micrometer, 2, 3, 4, 5, 7, 10, 15, 20, 25, 30, 35, 40, 45, or 50 micrometers.

The non-uniform filler particles may include a smaller pore size than known fillers used in acoustic applications. For example, the smallest pores of the activated carbon may have a diameter of less than 2 nm. The vermiform carbon generally has pores of several tens of micrometers in diameter, but no pores in the nanometer or sub-nanometer range. Generally, the non-uniform filler may have a minimum pore size up to 500 nm, up to 400 nm, up to 300 nm, up to 200 nm, up to 100 nm, up to 50 nm, up to 20 nm, up to 10 nm, up to 5 nm, up to 2 nm, or up to 1 nm.

The non-uniform filler may have a number average pore volume of from 0.01 cm³/g to 5 cm³/g. In some embodiments, the number average pore volume may be less than, equal to, or greater than 0.01, 0.02, 0.05, 0.07, 0.1, 0.2, 0.3, 0.4, 0.5, 0.7, 1, 1.2, 1.4, 1.6, 1.8, 2, 2.5, 3, 3.5, 4, 4.5, or 5 cm³/g.

As previously mentioned, the use of two or more different types of non-uniform fillers may be effective to improve the acoustic response of the composite article. In some embodiments, two or more different types of fillers are mixed into the porous layer of the acoustic article. In other embodiments, different types of fillers are mixed into the particulate bed adjacent to one or two porous layers within the acoustic article. In other embodiments, different types of fillers are present, but may be disposed in separate layers and independently provided in a porous layer or a particulate bed.

When the non-uniform filler is a particulate mixture of two or more fillers, the mixture can include a first non-uniform filler having an average surface area up to 1300 m²/g and a second non-uniform filler having an average surface area of at least 1300 m²/g. Alternatively, the mixture can include a first non-uniform filler having an average surface area of up to 500 m²/g and a second non-uniform filler having an average surface area of at least 500 m²/g. Alternatively, the mixture can include a first non-uniform filler having an average surface area of up to 100 m²/g and a second non-uniform filler having an average surface area of at least 100 m²/g. Alternatively, the mixture can include a first non-uniform filler having an average surface area of up to 10 m²/g and a second non-uniform filler having an average surface area of at least 10 m²/g.

Further, the mixture can include a non-uniform filler having a number average pore volume of up to 500 nanometers and a second non-uniform filler having a number average pore volume of at least 500 nanometers. Alternatively, the mixture can include a non-uniform filler having a number average pore volume of up to 1 micrometer and a second non-uniform filler having a number average pore volume of at least 1 micrometer.

As yet another example, the filler may be composed of two or more different filler compositions, such as combinations of activated carbon, vermiform carbon, zeolites, metal organic structures (MOF), perlite, alumina, glass bubbles, and glass beads.

As another example, the acoustic member 10 may include at least one of a fibrous nonwoven fabric layer and adhesive fibers. These fibers may be composed of polypropylene, polyethylene terephthalate, styrene-isoprene-styrene, or polyethylene/polypropylene copolymers.

The air-flow resistance value of the acoustic member 10 may be 100 MKS Rayls or more and 8000 MKS Rayls or less. The air-flow resistance value of the acoustic member 10 may be 100 MKS Rayls or more and 5000 MKS Rayls or less; 20 MKS Rayls or more and 3000 MKS Rayls or less; or 50 MKS Rayls or more and 1000 MKS Rayls or less. In addition, the air-flow resistance value of the acoustic member 10 may be any of 20 MKS Rayls, 30 MKS Rayls, 40 MKS Rayls, 50 MKS Rayls, 70 MKS Rayls, 100 MKS Rayls, 200 MKS Rayls; 300 MKS Rayls, 400 MKS Rayls, 500 MKS Rayls, 600 MKS Rayls, 700 MKS Rayls, 1000 MKS Rayls, 1100 MKS Rayls; 1200 MKS Rayls, 1500 MKS Rayls, 1700 MKS Rayls, 2000 MKS Rayls, 3000 MKS Rayls, 3500 MKS Rayls, 4000 MKS Rayls; 5000 MKS Rayls, 5500 MKS Rayls, 6000 MKS Rayls, 6500 MKS Rayls, 7000 MKS Rayls, 7500 MKS Rayls, and 8000 MKS Rayls.

The filler of the acoustic member 10 may be non-uniformly dispersed in the porous layer of the acoustic member 10. The filler of the acoustic member 10 may be received in the porous layer. The acoustic member 10 may include a nonwoven fibrous web. The filler may be diatomaceous earth, plant-based fillers, unexpanded graphite, polyolefin foam, or a combination thereof. Further, the amount of the filler in the acoustic member 10 may be 1 mass % or more and 99 mass % or less; 10 mass % or more and 90 mass % or less; 15 mass % or more and 85 mass % or less; 20 mass % or more and 80 mass % or less; 1 mass % or less; 1 mass % or more; or 2 mass %, 3 mass %, 4 mass %, 5 mass %, 7 mass %, 10 mass %, 12 mass %, 15 mass %, 20 mass %, 30 mass %, 35 mass %, 40 mass %, 45 mass %, 50 mass %, 55 mass %, 60 mass %, 65 mass %, 70 mass %, 75 mass %, 80 mass %, 85 mass %, 90 mass %, 95 mass %, 97 mass %, 98 mass %, or 99 mass % or less. The filler of the acoustic member 10 may be at least one of clay, diatomaceous earth, graphite, glass bubbles, porous carbon, porous fine fillers, polymeric fillers, non-layered silicates, plant-based fillers, and combinations thereof.

As described above, the acoustic member 10 may have a porous layer, and the average inter-fiber distance of the porous layer may be greater than 0 μm and 100 μm or less. The average inter-fiber distance of the acoustic member 10 may be 1 μm or more and 1000 μm or less, 10 μm or more and 500 μm or less, or 20 μm or more and 300 μm or less. Further, the average inter-fiber distance of the acoustic member 10 may be any of 1 μm, 2 μm, 3 μm, 4 μm, 5 μm, 7 μm, 10 μm, 11 μm, 12 μm, 15 μm, 17 μm, 20 μm, 25 μm, 30 μm, 35 μm, 40 μm, 45 μm, 50 μm, 60 μm, 70 μm, 80 μm, 90 μm, 100 μm, 110 μm, 120 μm, 130 μm, 150 μm, 170 μm, 200 μm, 250 μm, 300 μm, 400 μm, 450 μm, 500 μm, 600 μm, 700 μm, 800 μm, 900 μm, and 1000 μm.

As described above, the acoustic member 10 may be constituted of fine particles. In this case, the average particle size of the acoustic member 10 may be 1 μm or more and 1000 μm or less, 50 μm or more and 800 μm or less, or 100 μm or more and 700 μm or less. The average particle size of the acoustic member 10 may be less than 1 μm, or greater than 1000 μm. The average particle size of the acoustic member 10 may be any of 25 μm, 30 μm, 35 μm, 40 μm, 45 μm, 50 μm, 60 μm, 70 μm, 80 μm, 90 μm, 100 μm, 110 μm, 120 μm, 150 μm, 170 μm, 200 μm, 250 μm, 300 μm, 350 μm, 400 μm, 450 μm, 500 μm, 600 μm, 700 μm, 800 μm, 900 μm, and 1000 μm.

The thickness of the exemplary acoustic member 10 may be 1 μm or more and 10 cm or less, 30 μm or more and 1 cm or less, or 50 μm or more and 500 μm or less. The thickness of the acoustic member 10 may be any of 1 μm, 2 μm, 5 μm, 10 μm, 20 μm, 30 μm, 40 μm, 50 μm, 100 μm, 200 μm, 500 μm, 1 mm, 2 mm, 5 mm, 10 mm, 20 mm, 50 mm, 70 mm, and 100 mm.

When the acoustic member 10 includes the filler described above, it is possible to increase the absorption performance for sound in various frequency bands. The frequency band of sound in which the acoustic member 10 exhibits a high sound absorption performance may be, for example, 50 Hz or higher and 500 Hz or less; or 500 Hz or higher. The sound frequency for the acoustic member 10 may be any of 50 Hz, 55 Hz, 60 Hz, 65 Hz, 70 Hz, 75 Hz, 80 Hz, 85 Hz, 90 Hz, 95 Hz, 100 Hz, 105 Hz, 110 Hz, 115 Hz, 120 Hz, 125 Hz, 130 Hz 135 Hz, 140 Hz, 145 Hz, 150 Hz, 155 Hz, 160 Hz, 165 Hz, 170 Hz, 175 Hz, 180 Hz, 185 Hz, 190 Hz, 195 Hz, 200 Hz, 230 Hz, 240 Hz, 250 Hz, 260 Hz, 270 Hz, 280 Hz, 290 Hz, 300 Hz, 400 Hz, 500 Hz, 700 Hz, 1000 Hz, 2000 Hz, 3000 Hz, 4000 Hz, 5000 Hz, 7000 Hz, and 10000 Hz.

The acoustic member 10 may include nonwoven fabric or may include glass fibers. The glass fibers are generally made by melting silica or other mineral in an oven. The melted silica or the like may be produced by passing through a spinneret containing a small orifice and being extruded to produce a molten stream, and then being guided by the flow of hot air and cooled.

Next, the operation and effects of the ventilation system 1 and the acoustic member 10 according to the embodiments will be described. As illustrated in FIG. 4, in the ventilation system 1, the acoustic member 10 includes the film-like body portion 11 opposed to the outlet E formed in the wall W. Since the body portion 11 of the acoustic member 10 is opposed to the outlet E, sound from the outlet E can be effectively absorbed and insulated by the acoustic member 10 to improve sound absorption and sound insulation.

The body portion 11 of the acoustic member 10 partitions the internal space S of the ventilation system 1 into the first air chamber S1 communicating with the outlet E, and the second air chamber S2 into which the air K flows from the inlet 2c of the ventilation system 1. The body portion 11 defines the first air chamber S1 and the second air chamber S2 in this manner, thereby absorbing and insulating the sound T from the outlet E more effectively. Further, the portion 11b of the body portion 11 of the acoustic member 10 is fixed to the periphery portion 12 of the acoustic member 10, and the remainder 11c of the outer edge of the body portion 11 is the communicating portion 13 that allows the first air chamber S1 to communicate with the second air chamber S2. Thus, the air K flowing into the second air chamber S2 from the inlet 2c can be passed to the outlet E through the communicating portion 13 and the first air chamber S1. Therefore, it is possible to prevent the flow of the air K from being inhibited.

As illustrated, the ventilation system 1 may include the inner member 2 that defines the second air chamber S2 together with the body portion 11, and the inlet 2c may be formed in the inner member 2. In this case, the inlet 2c where the air K flows into the second air chamber S2 can be formed in the inner member 2 mounted to the inner side of the wall W.

The inner member 2 may be connected to the wall W. In this case, by mounting the inner member 2 to the wall W, installation of the ventilation system 1 can be easily installed in the wall W.

As described above, the lower portion (the portion 11b) of the outer edge of the body portion 11 may be fixed to the periphery portion 12. In this case, since the lower portion of the body portion 11 is fixed and the communicating portion 13 is formed in the upper portion of the body portion 11, the air K flowing from the inlet 2c can be guided to the outlet E via the communicating portion 13 formed in the upper portion.

In the communicating portion 13, the air K flowing into the second air chamber S2 from the inlet 2c may flow into the first air chamber S1, and in the outlet E, the air K flowing into the first air chamber S1 from the communicating portion 13 may be discharged from the first air chamber S1. In this case, since the air K flowing into the second air chamber S2 from the inlet 2c can be guided to the outlet E via the communicating portion 13 and the first air chamber S1, a flow of the air K can be formed and the flow of the air K can be prevented from being inhibited.

For example, the body portion 11 is shaped like a film extending in the first direction D1 and the second direction D2, the wall W and the body portion 11 are aligned along the third direction D3 intersecting both of the first direction D1 and the second direction D2, the outlet E and the inlet 2c are formed on one side in the first direction D1, and the communicating portion 13 may be formed on the other side in the first direction D1. As another example of this example, the outlet E and the inlet 2c are formed on one side in the second direction D2, and the communicating portion 13 may be formed on the other side in the second direction D2. That is, the outlet E and the inlet 2c are formed on one side in the first direction D1 and the second direction D2, and the communicating portion 13 may be formed on the other side in the first direction D1 and the second direction D2. In this case, for the sound T from the outlet E, a bypass path extending in the first direction D1 or the second direction D2 can be formed between the outlet E, the communicating portion 13, and the inlet 2c. This can improve sound absorption and sound insulation with respect to the sound T from the outlet E.

For example, one side in the first direction D1 and the second direction D2 is the lower side, and the other side in the first direction D1 and the second direction D2 is the upper side. In this case, for the sound T from the outlet E, a bypass path extending in the direction intersecting the third direction D3 (for example, vertical direction) can be formed between the outlet E, the communicating portion 13, and the inlet 2c.

The wall W may include the outer wall W2 and the inner wall W1, and the outlet E may be formed in the outer wall W2. At least a portion of the periphery portion 12 may be mounted to the inner wall W1. In this case, the ventilation system 1 can be mounted to the wall W that includes the outer wall W2 and the inner wall W1, and the outlet E is formed in the outer wall W2.

The outer wall W2 may be an outer panel of an automobile, the inner wall W1 may be an inner panel of an automobile, and the outlet E may be a vent duct of an automobile. In this case, it is possible to improve sound absorption and sound insulation in the automobile provided with the outer panel, the inner panel, and the vent duct, preventing the flow of the air K from being inhibited.

The inner member 2 may be a luggage side trim that covers the inner side of the wall W. In this case, the ventilation system 1 can be easily installed to the inner side of the wall W by mounting the luggage side trim to the inner side of the wall W.

The acoustic member 10 may include a nonwoven fabric. In this case, the configuration of the acoustic member 10 can be simplified.

The acoustic member 10 may include the skin layer 10d and the core layer 10b that are made of different materials. In this case, the core layer 10b and the skin layer 10d each can absorb sound to further improve sound absorption of the acoustic member.

The acoustic member 10 may include the porous layer and the non-uniform filler that contacts the porous layer, includes porous carbon, and has an average surface area of 0.1 m²/g or more and 10000 m²/g or less, and the acoustic member 10 may have an air-flow resistance value of 100 MKS Rayls or more and 5000 MKS Rayls or less.

The acoustic member 10 may include the porous layer and the non-uniform filler that is received in the porous layer, that has an average particle size of 1 μm or more and 1000 μm or less, and that has an average surface area of 0.1 m²/g or more and 800 m²/g or less, and the acoustic member 10 may have an air-flow resistance value of 100 MKS Rayls or more and 8000 MKS Rayls or less.

The acoustic member 10 according to the embodiments includes the film-like body portion 11, and the periphery portion 12 that is connected to the portion 11b of the outer edge of the body portion 11 and that surrounds the body portion 11.

In the acoustic member 10, since the film-like body portion 11 is opposed to the outlet E, the sound T from the outlet E can be effectively absorbed and insulated by the body portion 11 to improve sound absorption and sound insulation. Since the acoustic member 10 includes the periphery portion 12 that is connected to the portion 11b of the outer edge of the body portion 11 and that surrounds the body portion 11, the remainder 11c of the outer edge of the body portion 11 can be open when the periphery portion 12 is mounted to the wall W or the like. This open portion can be a passage for the air K so as to prevent the flow of the air K from being inhibited. The periphery portion 12 may be formed by thermal pressing. Additionally, the periphery portion 12 may be formed of a frame. In this case, the periphery portion 12 can be easily formed.

The body portion 11 may partition a predetermined space into the first air chamber S1 and the second air chamber S2, and the portion 11b of the outer edge of the body portion 11 may be fixed to the periphery portion 12. The remainder 11c of the outer edge of the body portion 11 may be open, or may be the communicating portion 13 that allows the first air chamber S1 to communicate with the second air chamber S2. In this case, since the body portion 11 is opposed to the outlet E and partitions a predetermined space into the first air chamber S1 and the second air chamber S2, the sound T from the outlet E can be effectively absorbed and insulated. Additionally, since the remainder 11c of the outer edge of the body portion 11 is the communicating portion 13 that allows the first air chamber S1 to communicate with the second air chamber S2, the inflowing air K can be passed to the outlet E through the communicating portion 13. Therefore, it is possible to prevent the flow of the air K from being inhibited.

The embodiments of the ventilation system and the acoustic member according to the present disclosure have been described above. However, the present disclosure is not limited to the above-mentioned embodiments. The present disclosure can be variously modified without departing from the subject matter described in the claims. That is, the shape, size, material, number, and arrangement of each of the portions of the ventilation system and the acoustic member can be changed as appropriate so as not to change the subject matter described above. For example, in the embodiment described above, the lower portion of the outer edge of the body portion 11 is fixed to the periphery portion 12. For example, when viewed from the third direction D3, the periphery portion 12 may be provided on the entire circumference or partial circumference. For example, the periphery portion 12 may be present around the entire circumference and a hole may be perforated to form the communicating portion 13 in the acoustic member. In this manner, the shape of the periphery portion and the body portion of the acoustic member can be changed as appropriate within the scope of the subject matter described above.

Subsequently, various examples of ventilation systems and the acoustic member will be described. Note that the present disclosure is not limited to examples including Examples described below. First, specifications of each of Examples 1 to 4 and Comparative Example 1 will be described below.

### Example 1

Similar to the acoustic member 10 described above, an acoustic member according to Example 1 includes a core layer and skin layers each provided on a pair of main surfaces of the core layer. In the acoustic member according to Example 1, polypropylene (PP) resin spun as meltblown fibers in the melt blowing process such that the meltblown fibers having a fiber diameter of 5 μm were 700 g/m² per unit area, and activated carbon 175 g/m² having a surface area of 250 m²/g as porous particles were used to produce a mixed web. The thickness and the weight per unit area of the acoustic member according to Example 1 were 15 mm and 875 g/m², respectively. The air-flow resistance value of the acoustic member was 5000 MKS Rayls. The acoustic member according to Example 1 was mounted to the first region A1 and the second region A2 of the wall W illustrated in FIGS. 3 and 4 to form a ventilation system according to Example 1. The surface area of the activated carbon was analyzed using AUTOSORB IQ (Quantachrome Instruments (Boynton Beach, Florida)). The surface area was determined by N₂ adsorption at 77 K. The air-flow resistance value was measured according to ASTM C-522-03 (Reproved 2009), “Standard Test Method for Airflow Resistance of Acoustical Materials”. An instrument used for measurement was PERMEAMETER Model Number GP-522-A, available from POROUS Materials, Inc. (Ithaca, NY). Then, the air-flow resistance value was calculated in units of Rayls (Pa s/m).

### Example 2

The acoustic member according to Example 2 is constituted of 3M (trade name) Thinsulate (trade name) sound-absorbing heat-insulating member TC3403. The acoustic member according to Example 2 includes a core layer and skin layers each provided on a pair of main surfaces of the core layer. The acoustic member according to Example 2 includes a high-function stuffing material. The acoustic member according to Example 2 includes complexly entangled microfibers and staple fibers. The thickness and the weight per unit area of the acoustic member according to Example 2 were 41 mm and 332 g/m², respectively. The acoustic member according to Example 2 was mounted to the first region A1 and the second region A2 of the wall W illustrated in FIGS. 3 and 4 to form a ventilation system according to Example 2.

### Example 3

The acoustic member according to Example 3 was constituted of a cloth felt (sound-absorbing hair felt WSD007 available from Wakisangyo Co., Ltd.). The acoustic member according to Example 3 was constituted of a monolayer including only hair felt. The thickness and the weight per unit area of the acoustic member according to Example 3 were 8 mm and 1000 g/m², respectively. The acoustic member according to Example 3 was mounted to the first region A1 and the second region A2 of the wall W illustrated in FIGS. 3 and 4 to form a ventilation system according to Example 3.

### Example 4

The acoustic member according to Example 4 was a rubber plate (NBR rubber sheet NBR310005 available from Wakisangyo Co., Ltd.). The thickness and the weight per unit area of the acoustic member according to Example 4 were 3 mm and 4300 g/m², respectively. The acoustic member according to Example 4 was mounted to the first region A1 and the second region A2 of the wall W illustrated in FIGS. 3 and 4 to form a ventilation system according to Example 4.

### Comparative Example 1

A ventilation system having no acoustic member was used as Comparative Example 1.

An experiment of comparing acoustic sensitivity was performed on automobiles equipped with respective vehicle bodies having ventilation systems in Examples 1 to 4 and Comparative Example 1, respectively. The automobiles with the respective ventilation systems in Examples 1 to 4 and Comparative Example 1 were placed in an anechoic room, and static evaluation of acoustic sensitivity was performed inside the anechoic room.

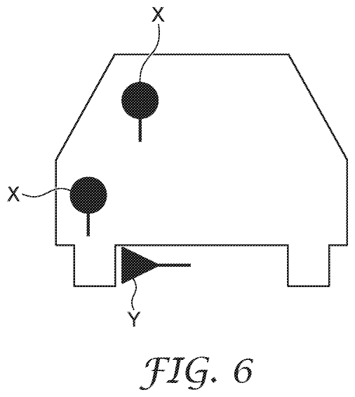

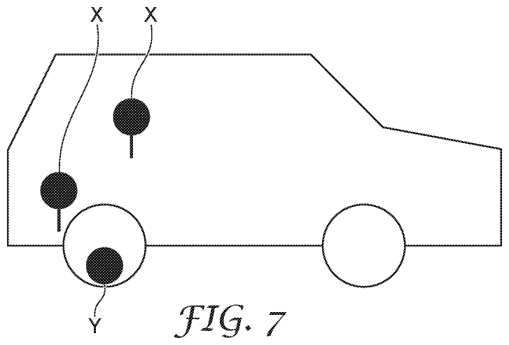

As illustrated in FIG. 6 and FIG. 7, a speaker Y that was a sound source was mounted to the inner side of a rear wheel of an automobile, and two microphones X were mounted to the inner side of the vehicle body of the automobile. The microphones X were each disposed around the inlet of the luggage side trim and on the upper portion of a left rear seat (located at an occupant's ear). In each of Examples 1 to 4 and Comparative Example 1, sound was excited by vibrating (white noise) by a speaker Y serving as a volume velocity sound source, and detected by the microphones X that was ½ microphones. The detected sound was subjected to frequency analysis (CPB analysis: 400 to 5000 Hz) using an FFT analyzer, and the magnitude of noise per frequency was measured. OmniSource Sound Source Type 4295 available from B&K was used as the volume velocity sound source, and 4189-A-021 available from B&K was used as the ½ microphone. PULSE available from B&K was used as the FFT analyzer.

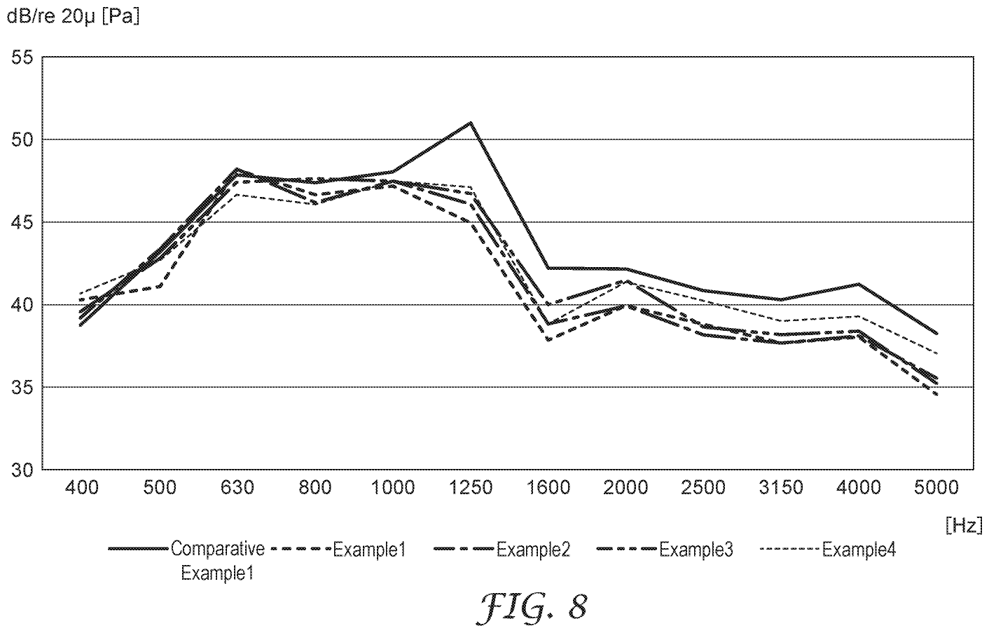

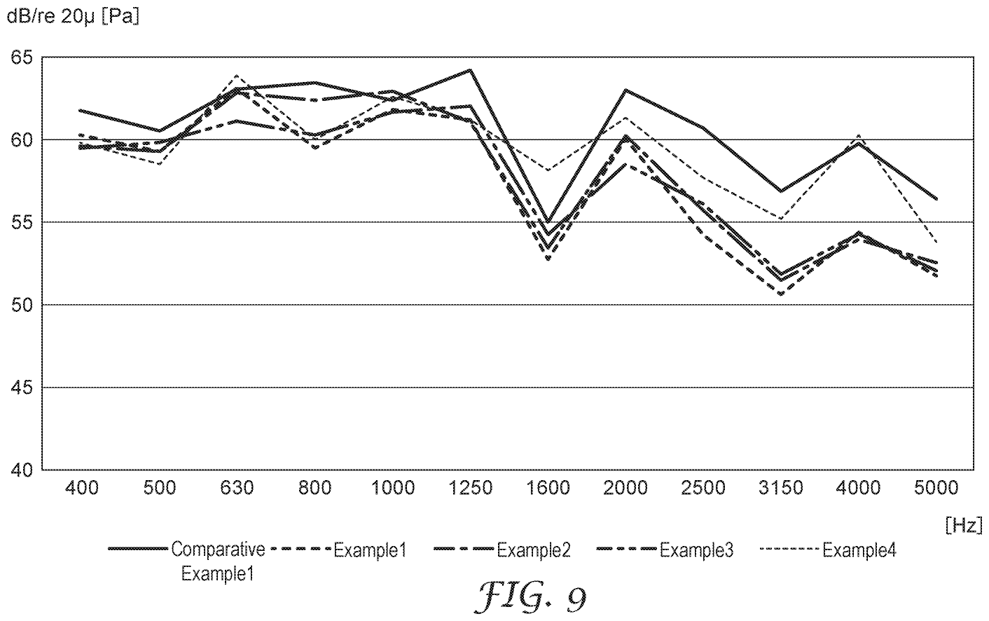

Results of the above-mentioned noise measurements on each of the ventilation systems in Examples 1 to 4 and Comparative Example 1 are illustrated in FIGS. 8 and 9. FIG. 8 illustrates measurements of noise detected by the microphone X disposed on the left rear seat, and FIG. 9 illustrates measurements of noise detected by the microphone X disposed around the inlet of the luggage side trim.

As illustrated in FIG. 8, at the left rear seat, it was found that the sound absorption and sound insulation in the frequency band of 400 Hz to 5000 Hz was improved in the ventilation system in Examples 1 to 4 provided with the acoustic member, as compared to the ventilation system in Comparative Example 1. In the frequency band of 400 Hz to 5000 Hz, the average value of noise in Example 1 was 41.30 dB, the average value of noise in Example 2 was 41.59 dB, the average value of noise in Example 3 was 41.94 dB, the average value of noise in Example 4 was 42.22 dB, and the average value of noise in Comparative Example 1 was 43.44 dB.

Thus, it was found that, as compared to the ventilation system in Comparative Example 1, the ventilation system in Example 1 could reduce noise by approximately of 2.1 dB, the ventilation system in Example 2 could reduce noise by approximately 1.9 dB, the ventilation system in Example 3 could reduce noise by approximately of 1.5 dB, and the ventilation system in Example 4 could reduce noise by approximately 1.2 dB.

As illustrated in FIG. 9, it was found that, as compared to the ventilation system in Comparative Example 1, the ventilation system of Examples 1 to 3 with the fibrous acoustic member could improve sound absorption and sound insulation in the frequency band of 400 Hz to 5000 Hz, around the inlet of luggage side trim. In Example 4 provided with the acoustic member that is the rubber plate, some noise values were high depending on the frequency, but the noise values were generally better than those in Comparative Example 1.

In the frequency band of 400 Hz to 5000 Hz, the average value of noise in Example 1 was 57.50 dB, the average value of noise in Example 2 was 58.06 dB, the average value of noise in Example 3 was 57.70 dB, the average value of noise in Example 4 was 58.82 dB, and the average value of noise in Comparative Example 1 was 60.71 dB.

Thus, it was found that, as compared to the ventilation system in Comparative Example 1, the ventilation system in Example 1 could reduce noise by approximately of 3.2 dB, the ventilation system in Example 2 could reduce noise by approximately 3 dB, the ventilation system in Example 3 could reduce noise by approximately of 2.6 dB, and the ventilation system in Example 4 could reduce noise by approximately 1.9 dB. From the above, it was found that the ventilation systems in Examples 1 to 4 having an acoustic member similar to the acoustic member 10 illustrated in FIG. 4 could enhance sound absorption and sound insulation.

### REFERENCE SIGNS LIST

1 Ventilation system, 2 Inner member, 2b Convex portion, 2c Inlet, 10 Acoustic member, 10b Core layer, 10c Main surface, 10d Skin layer, 11 Body portion, 11b Portion, 11c Remainder, 12 Periphery portion, 13 Communicating portion, A1 First region, A2 Second region, B Vehicle body, D1 First direction, D2 Second direction, D3 Third direction, E Outlet, E1 Short side, E2 Long side, F Flap, K Air, S Internal space, S1 First air chamber, S2 Second air chamber, T Sound, W Wall, W1 Inner wall, W13 Convex portion, W2 Outer wall, W21 First wall portion, W22 Second wall portion, W3 Rear bumper, X Microphone, Y Speaker

1. A ventilation system with an inlet and an outlet, the ventilation system being mounted to a wall, the ventilation system comprising:
an acoustic member absorbing sound from the outlet, wherein
the acoustic member includes
a body portion having a film-like shape, the body portion opposed to the outlet and
a periphery portion disposed to connect the body portion to the wall, the periphery portion disposed to surround the body portion,
the body portion defines a first air chamber communicating with the outlet and a second air chamber into which air flows from the inlet,
a portion of an outer edge of the body portion is fixed to the periphery portion, and
a remainder of the outer edge of the body portion is open and is a communicating portion allowing the first air chamber to communicate with the second air chamber.

2. The ventilation system according to claim 1, further comprising:
an inner member defining the second air chamber together with the body portion, wherein the inlet is formed in the inner member.

3. The ventilation system according to claim 2, wherein the inner member is connected to the wall.

4. The ventilation system according to claim 1, wherein a lower portion of the outer edge of the body portion is fixed to the periphery portion.

5. The ventilation system according to claim 1, wherein
in the communicating portion, air flowing from the inlet into the second air chamber flows into the first air chamber, and
at the outlet, the air flowing from the communicating portion into the first air chamber is discharged from the first air chamber.

6. The ventilation system according to claim 1, wherein
the body portion has a film-like shape extending in a first direction and a second direction,
the wall and the body portion are aligned along a third direction, the third direction intersecting both of the first direction and the second direction,
the outlet and the inlet are formed on one side in any of the first direction and the second direction, and
the communicating portion is formed on an other side in any of the first direction and the second direction.

7. The ventilation system according to claim 6, wherein
the one side in the first direction and the second direction is a lower side, and
the other side in the first direction and the second direction is an upper side.

8. The ventilation system according to claim 1, wherein
the wall includes an outer wall and an inner wall,
the outlet is formed in the outer wall, and
at least a portion of the periphery portion is mounted to the inner wall.

9. The ventilation system according to claim 8, wherein
the outer wall is an outer panel of an automobile, and the inner wall is an inner panel of the automobile, and
the outlet is a vent duct of the automobile.

10. The ventilation system according to claim 2, wherein the inner member is a luggage side trim covering an inner side of the wall.

11. The ventilation system according to claim 1, wherein the acoustic member includes a nonwoven fabric.

12. The ventilation system according to a claim 1, wherein the acoustic member includes a skin layer and a core layer that includes a material different from a material of the skin layer.

13. The ventilation system according to a claim 1, wherein
the acoustic member includes
a porous layer and
a non-uniform filler in contact with the porous layer, the non-uniform filler containing porous carbon and having an average surface area of 0.1 m²/g or more and 10000 m²/g or less, and
the acoustic member has an air-flow resistance value of 100 MKS Rayls or more and 5000 MKS Rayls or less.

14. The ventilation system according to claim 1, wherein
the acoustic member includes
a porous layer and
a non-uniform filler received in the porous layer, the non-uniform filler having an average particle size of 1 μm or more or 1000 μm or less and having an average surface area of 0.1 m²/g or more and 800 m²/g or less, and
the acoustic member has an air-flow resistance value of 100 MKS Rayls or more and 8000 MKS Rayls or less.

15. An acoustic member comprising:
a body portion having a film-like shape; and
a periphery portion formed to be connected to a portion of an outer edge of the body portion, the periphery portion formed to surround the body portion.

16. The acoustic member according to claim 15, wherein the periphery portion is formed by thermal pressing.

17. The acoustic member according to claim 15, wherein the periphery portion is formed of a frame.

18. The acoustic member according to claim 15, wherein
the body portion partitions a predetermined space into a first air chamber and a second air chamber,
the portion of the outer edge of the body portion is fixed to the periphery portion, and
a remainder of the outer edge of the body portion is open and is a communicating portion allowing the first air chamber to communicate with the second air chamber.
